(19) United States
(12) Patent Application Publication
(10) Pub. No.: US 2022/0073732 A1
(43) Pub. Date: Mar. 10, 2022

(54) RESIN COMPOSITION AND RESIN MOLDED ARTICLE COMPRISING THE SAME

(71) Applicant: ENEOS Corporation, Tokyo (JP)

(72) Inventor: Gosuke WASHINO, Tokyo (JP)

(73) Assignee: ENEOS Corporation, Tokyo (JP)

(21) Appl. No.: 17/416,761

(22) PCT Filed: Dec. 26, 2019
(86) PCT No.: PCT/JP2019/051098

§ 371 Date: Jun. 21, 2021

(30) Foreign Application Priority Data
Dec. 27, 2018 (JP) 2018-246060

(51) Int. Cl. C08L 67/04; C08G 63/60; C08L 27/18

(52) U.S. Cl. CPC C08L 67/04; C08L 2203/20; C08L 27/18; C08G 63/605

(57) ABSTRACT

The invention provides a resin composition having low dielectric loss tangent and low permittivity as well as having melt molding processability and heat resistance comparable to those of a liquid crystal polyester resin. In particular, the invention provides a resin composition containing a liquid crystal polyester resin (A) comprising: structural unit (I) derived from a hydroxycarboxylic acid, structural unit (II) derived from a diol compound, and structural unit (III) derived from a dicarboxylic acid; and a fluorine resin (B), wherein the dielectric loss tangent is 0.80×10⁻³ or less and the relative permittivity is 3.50 or less when measured by a split post dielectric resonator (SPDR) method at a measurement frequency of 10 GHz.

### BACKGROUND OF THE INVENTION

### Field of the Invention

The present invention relates to a resin composition having low dielectric loss tangent and low permittivity. The present invention also relates to a resin molded article made of the resin composition and an electric/electronic component comprising the resin molded article.

### Background Art

Signals having a frequency in the high frequency band have been used more in electronic instruments, communication instruments, etc. in recent years, along with the increase in the amount of information communication in the communication field, and particularly, active use is made in signals having a frequency in the gigahertz (GHz) band having a frequency of 10⁹ Hz or more. However, as the frequencies of signals used get higher, the quality of output signals decreases, which may lead to recognizing information erroneously, i.e., transmission loss increases. This transmission loss is consisted of a conductor loss caused by the conductor and a dielectric loss caused by a resin composition for insulation which forms the electric/electronic component such as substrates in electronic and communication instruments, and as the conductor loss is proportional to 0.5^{th} power of the frequency to be used and the dielectric loss is proportional to 1^{st} power of the frequency, the effect of this dielectric loss becomes extremely large in the high frequency band, in particular, in the GHz band. Further, since the dielectric loss increases proportionally also to the dielectric loss tangent and the permittivity of the resin composition, there is a need for a resin composition having low dielectric loss tangent and low permittivity, in order to prevent deterioration of information.

In recent years, liquid crystal polyester resins have attracted attention because they are a thermoplastic resin having both low viscosity and high heat resistance and have a dielectric loss tangent one digit smaller than insulating materials for substrates such as polyimide. Liquid crystal polyester resins have been designed from the viewpoint of the structure of the raw material monomer. For example, there has been proposed that a monomer having bulky substituents is copolymerized with a liquid crystal polyester resin to reduce permittivity (refer to Patent Document 1). There has also been proposed that dielectric loss tangent is reduced by using a monomer having a naphthalene ring as a raw material monomer. However, it has not yet been achieved to reduce both the dielectric loss tangent and the permittivity while in the state of maintaining excellent processability derived from the characteristics of the liquid crystal polyester resin, which are high heat resistance and low viscosity at the time of melting.

As a material designing method other than monomer designing, there is also known a means to develop a material having excellent characteristics by kneading or blending a filler or another resin into a liquid crystal polyester resin. For example, it has been proposed to knead a hollow glass balloon filler having an air layer into a liquid crystal polyester resin (refer to Patent Document 2). Since the air has an extremely low permittivity of 1, it is possible to lower the permittivity by blending into a resin. However, since the hollow glass balloon greatly inhibits the liquid crystallinity of the liquid crystal polyester resin, even a small amount of the hollow glass balloon kneaded increases the viscosity significantly. Accordingly, as the processability of the resin composition significantly decreases, practically, kneading can be done only in a small amount of approximately 10% by mass or less of the entire resin composition. Further, because of the hollow state, there is also the problem that the kneaded material is fragile and thus the mechanical strength and heat resistance of the material decrease.

Further, as a known means to lower the dielectric loss tangent, a ceramic such as magnesium oxide or boron nitride is kneaded and blended into the liquid crystal polyester resin. However, although the ceramic material has a low dielectric loss tangent of 10⁻⁴ to 10⁻⁵, the permittivity is 8 or more, and in some cases, it is extremely high as about 80, and thus the permittivity of the kneaded material rises in contrast.

As materials having both extremely low dielectric loss tangent and permittivity, fluorine-based materials have been known, In particular, a polytetrafluoroethylene resin (PTFE) has a permittivity of about 2 and is known to have excellent electrical characteristics as the dielectric loss tangent is in the 10⁻⁴ range. On the other hand, PTFE is known to have an extremely high viscosity in a molten state and cannot be subjected to melt-process such as injection molding or film formation by melt-extrusion. The only processing method is a cutting process in which a compressed block is cut; however, such a method has not been able to achieve high productivity and fine processing as like in injection molding. As a method for improving the processability of PTFE, there has been developed a fluorine material such as tetrafluoroethylene-perfluoroalkyl vinyl ether copolymer resin (PFA) in which the structure of PTFE is changed. These materials have lower viscosity than PTFE and can be processed into films, etc., but cannot maintain the low dielectric loss tangent and low permittivity of PTFE. For this reason, processability is improved at the expense of electrical properties, and therefore there is a demand for materials that can reduce both the dielectric loss tangent and permittivity while maintaining melt viscosity suitable for processing and heat resistance that ensures soldering heat resistance as a product.

### PRIOR ART DOCUMENT

### [Patent Document]

[Patent Document 1] WO2016/027446
[Patent Document 2] Japanese Unexamined Patent Publication No. 2004-27021

### SUMMARY OF THE INVENTION

### Problem to be Solved by the Invention

Accordingly, the problem to be solved by the present invention is to provide a resin composition having low dielectric loss tangent and low permittivity while having both melt molding processability and heat resistance comparable to those of a liquid crystal polyester resin. Further, a resin molded article made of such a resin composition is also provided.

### Means to Solve the Problem

The present inventors have conducted intensive studies to solve the above problem, and as a result, have found that the above problem can be solved by adjusting the dielectric loss tangent and the relative permittivity within specific numerical ranges in a resin composition obtained by mixing a specific liquid crystal polyester resin (A) and a fluorine resin (B). The present invention has been completed on the basis of the above finding.

That is, according to one aspect of the present invention, there is provided:

a resin composition comprising:

a liquid crystal polyester resin (A) comprising structural unit (I) derived from a hydroxycarboxylic acid, structural unit (II) derived from a diol compound, and structural unit (III) derived from a dicarboxylic acid; and

a fluorine resin (B),

wherein a dielectric loss tangent is 0.80×10⁻³ or less and a relative permittivity is 3.50 or less when measured by a SPDR method at a measurement frequency of 10 GHz.

In one embodiment of the present invention, the resin composition preferably has a melt viscosity of 5 Pa·s or more and 250 Pa·s or less under a temperature of a melting point of the liquid crystal polyester resin (A)+20° C. or higher and a shear rate of 1000 s⁻¹.

In one embodiment of the present invention, the liquid crystal polyester resin (A) preferably has a melt viscosity of 5 Pa·s or more and 130 Pa·s or less under a melting point+20° C. or higher and a shear rate of 1000 s⁻¹.

In one embodiment of the present invention, the liquid crystal polyester resin (A) preferably has a melting point of 280° C. or higher.

In one embodiment of the present invention, the liquid crystal polyester (A) preferably has a dielectric loss tangent of 1.00×10⁻³ or less measured by a 10 GHz SPDR method.

In one embodiment of the present invention, the resin (B) preferably comprises a polytetrafluoroethylene resin.

In one embodiment of the present invention, the amount of the liquid crystal polyester resin (A) blended is 30 parts or more by mass and 95 parts or less by mass, and the amount of the fluorine resin (B) blended is 5 parts or more by mass and 70 parts or less by mass, with respect to a total of 100 parts by mass of the liquid crystal polyester resin (A) and the fluorine resin (B).

In one embodiment of the present invention, the structural unit (I) derived from a hydroxycarboxylic acid is preferably a structural unit derived from 6-hydroxy-2-naphthoic acid.

In one embodiment of the present invention, the composition ratio of the structural unit (I) to the structural units of the entire liquid crystal polyester resin (A) is preferably 30 mol % or more and 80 mol % or less.

In one embodiment of the present invention, the structural unit (II) derived from a diol compound is preferably a structural unit derived from at least one selected from the group consisting of 4,4-dihydroxybiphenyl, hydroquinone, methylhydroquinone, and 4,4′-isopropylidenediphenol.

In one embodiment of the present invention, the structural unit (III) derived from a dicarboxylic acid is preferably a structural unit derived from at least one selected from the group consisting of terephthalic acid, isophthalic acid, and 2,6-naphthalenedicarboxylic acid.

According to another embodiment of the present invention, there is provided a resin molded article comprising the resin composition.

In another embodiment of the present invention, the resin molded article after the heat treatment preferably has a dielectric loss tangent of 0.70×10⁻³ or less measured by a SPDR method at a measurement frequency of 10 GHz.

In another embodiment of the invention, the water absorption rate measured in accordance with ASTM D570 is preferably 0.04% or less.

According to another further embodiment of the present invention, there is provided an electric/electronic component comprising the resin molded article.

### Effect of the Invention

According to the present invention, it is possible to obtain a resin composition having low dielectric loss tangent and low permittivity while having both melt molding processability and heat resistance comparable to those of a liquid crystal polyester resin. In addition, by using such a resin composition, it is possible to obtain a resin molded article having low dielectric loss tangent and low permittivity while having excellent heat resistance.

### BRIEF DESCRIPTION OF THE DRAWINGS

FIG. 1 is a graph showing a loss elastic modulus for calculating a practical heat resistant temperature of a resin molded article of Example 2-2,

### DETAILED DESCRIPTION OF THE INVENTION

### Mode for Carrying Out the Invention

### [Resin Composition]

A resin composition according to the present invention comprises a liquid crystal polyester resin (A) and a fluorine resin (B) as described below, and has low dielectric loss tangent and low permittivity while having both melt molding processability and heat resistance comparable to those of the liquid crystal polyester resin. By using such a resin composition, it is possible to obtain a resin molded article having low dielectric loss tangent and low permittivity while having excellent heat resistance.

From the viewpoint of melt molding processability, the lower limit of the melt viscosity of the resin composition is preferably 5 Pa·s or more, and the upper limit is preferably 250 Pa·s or less, more preferably 230 Pa·s or less, further preferably 200 Pa·s or less, and further more preferably 150 Pa·s or less, under a temperature of the melting point of the liquid crystal polyester resin (A)+20° C. or higher and a shear rate of 1000 s⁻¹.

Dielectric loss tangent (measurement frequency: 10 GHz) of the resin composition is 0.80×10⁻³ or less, preferably 0.75×10⁻³ or less, more preferably 0.70×10⁻³ or less, and further more preferably 0.65×10⁻³ or less. This value is a measurement value of the dielectric loss tangent of the injection molded article of the resin composition in the in-plane direction. When the melt viscosity of the resin composition is 150 Pa·s or less, such injection molded article is a flat plate test piece of 30 mm×30 mm×0.4 mm (thickness), and a flat plate test piece of 30 mm×30 mm×0.8 mm (thickness) when the melt viscosity of the resin composition is over 150 Pa·s and 250 Pa·s or less.

In the present specification, the dielectric loss tangent of the resin composition at 10 GHz can be measured by a split post dielectric resonator method (SPQR method) using a network analyzer N5247A of Keysight Technologies or the like, Unless otherwise specified, the value of the dielectric loss tangent is measured at 23° C. and 60% humidity in an atmospheric environment.

Relative permittivity of the resin composition measured by the SPGR method at 10 GHz is 3.5 or less, preferably 3.4 or less, more preferably 3.3 or less, and further preferably 3.2 or less. Dielectric loss factor F defined by equation (2) is preferably 2.0 or less, more preferably 1.8 or less, and further preferably 1.5 or less. The value of the dielectric loss in this specification is obtained by calculating the energy loss generated in the dielectric (insulating film) in the transmission loss in the circuit board by equation (1) below (see, Engineering literature (Development and Application of High-Frequency Polymer Materials, CMC Technical Library 201, supervised by Bunmei Baba, p. 120)).

[Equation 1]

α_{D}=27.3×(f/C)×(Er)^{1/2}×tan δ (1)

α_{D}: Dielectric Loss (dB/m)
f: frequency (Hz)
C: light speed
Er: relative permittivity
tan δ: dielectric loss tangent

According to this equation (1), it is possible to find out how much dielectric loss is occurring among the transmission loss which occurs when a circuit board is produced using a material by comparing the dielectric loss factor F at a specific frequency defined by the following equation (2) among the materials, and the smaller the value of the dielectric loss factor F is, the insulator can be expected as having a function for a low dielectric loss substrate.

[Equation 2]

F=(Er)^{1/2}×tan δ (2)

F: dielectric loss factor

The dielectric loss factor F in a specific frequency defined by the above equation (2) is a new parameter for comparing dielectric losses between the materials.

Hereinafter, each component contained in the resin composition will be described.

### (Liquid Crystal Polyester Resin (A))

The liquid crystal polyester resin used in the resin composition of the present invention comprises structural unit (I) derived from a hydroxycarboxylic acid, structural unit (II) derived from a diol compound, and a structural unit (III) derived from a dicarboxylic acid. Each structural unit contained in the liquid crystal polyester resin polyester resin will be described below.

(Structural Unit (I) Derived from Hydroxycarboxylic Acid)

Unit (I) constituting the liquid crystal polyester resin (A) is a structural unit derived from a hydroxycarboxylic acid, and preferably is a structural unit derived from an aromatic hydroxycarboxylic add represented by the following formula (I). Note that, only one of structural unit (I) may be comprised, or even 2 or more may be possible.

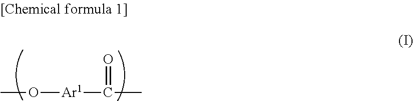

In the formula above, Ar¹ is selected from the group consisting of a phenyl group, biphenyl group, 4,4′-isopropilidene diphenyl group, naphthyl group, anthryl group, and phenanthryl group optionally having a substituent. Amongst these, a phenyl group, biphenyl group, and naphthyl group are preferred and more preferred is a naphthyl group, Examples of the substituent include a hydrogen atom, alkyl group, alkoxy group, and fluorine. The number of carbons the alkyl group has is preferably 1 to 10 and more preferably 1 to 5. The alkyl group may be of a straight chained or of a branched chained. The number of carbons the alkoxy group has is preferably 1 to 10 and more preferably 1 to 5.

Examples of the monomer that gives the structural unit represented by Formula (I) as above includes 6-hydroxy-2-naphthoic acid (HNA, Formula (1) below) and/or p-hydroxybenzoic acid (HBA, Formula (2) below), and acylated products, ester derivatives, acid halides thereof.

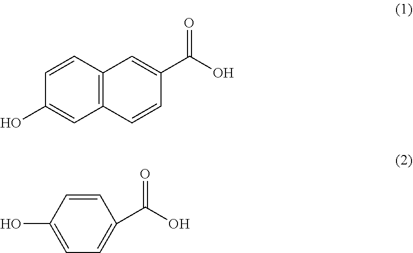

The composition ratio (mol %) of the structural unit (I) based on the structural units of the entire polyester resin has a lower limit of preferably 30 mol % or more, more preferably 35 mol % or more, further preferably 40 mol % or more, further more preferably 45 mol % or more, and an upper limit of preferably 80 mol % or less, more preferably 75 mol % or less, further preferably 70 mol % or less, further more preferably 65 mol % or less. When two or more structural units (I) are contained, the total molar ratio thereof may be within the range of the above composition ratio. Note that, the composition ratio of the structural unit derived from 6-hydroxy-2-naphthoic acid is preferably more than the composition ratio of the structural unit derived from 6-hydroxy benzoic acid. When two or more structural units (I) are contained, the composition ratio of the structural unit derived from 6-hydroxy-2-naphthoic acid is preferably more than 50 mol %, more preferably 70 mol % or more, and even more preferably 90 mol % or more of the total of the structural units (I).

(Structural Unit (II) Derived from Diol Compound)

The unit (II) constituting the liquid crystal polyester resin (A) is a structural unit derived from a diol compound, and is preferably a structural unit derived from an aromatic dial compound represented by formula (II) below. Only one of the structural unit (II) may be comprised, or even 2 or more may be possible.

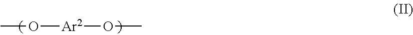

In the above formula, Ar² is selected from the group consisting of a phenyl group, biphenyl group, 4,4′-isopropylidene diphenyl group, naphthyl group, anthryl group, and phenanthryl group, optionally having a substituent. More preferred among these are a phenyl group and a biphenyl group. Examples of the substituent include hydrogen, an alkyl group, alkoxy group, and fluorine. The alkyl group preferably has 1 to 10 carbons and more preferably 1 to 5 carbons, The alkyl group may be linear alkyl groups or branched alkyl groups. The number of carbons contained in the alkoxy group is preferably 1 to 10 and more preferably 1 to 5.

Examples of the monomer which provides the structural unit (II) include 4,4′-dihydroxybiphenyl (BP, Formula (3) below), hydroquinone (HQ, Formula (4) below), methyl hydroquinone (MeHQ, Formula (5) below), 4,4′-isopropylidenediphenol (BisPA, Formula (6) below), and acyl derivatives, ester derivatives, and acid halides thereof and the like. Amongst these, preferred for use are 4,4′-dihydroxybiphenyl (BP) and acylated products, ester derivatives and acid halides thereof.

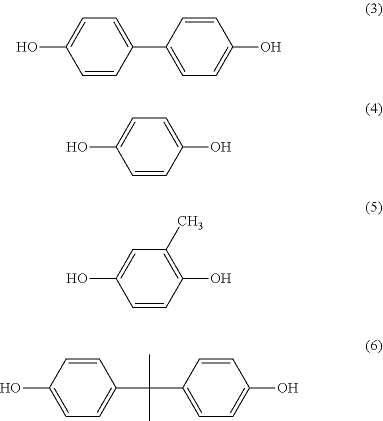

The composition ratio (mol %) of the structural unit (II) based on the structural units of the entire polyester resin has a lower limit of preferably 10 mol % or more, more preferably 12.5 mol % or more, further preferably 15 mol % or more, further more preferably 17.5 mol % or more, and an upper limit of preferably 35 mol % or less, more preferably 32.5 mol % or less, further preferably 30 mol % or less, further more preferably 27.5 mol % or less. When two or more structural units (II) are contained, the total molar ratio thereof may be within the ranges of the above composition ratio.

(Structural Unit (III) Derived from Aromatic Dicarboxylic Acid)

The unit (III) constituting the liquid crystal polyester resin (A) is a structural unit derived from a dicarboxylic acid, and preferably a structural unit derived from an aromatic dicarboxylic acid represented by the following Formula (III). Only one of the structural unit (III) may be comprised, or even 2 or more may be possible.

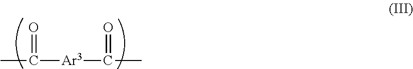

In the above formula, Ar³ is selected from the group consisting of a phenyl group, biphenyl group, 4,4′-isopropylidene diphenyl group, naphthyl group, anthryl group, and phenanthryl group, optionally having a substituent. More preferred among these are a phenyl group and a biphenyl group. Examples of the substituent include hydrogen, an alkyl group, an alkoxy group, fluorine, and the like. The alkyl group preferably has 1 to 10 carbons and more preferably 1 to 5 carbons. The alkyl group may be linear alkyl groups or branched alkyl groups. The number of carbons contained in the alkoxy group is preferably 1 to 10 and more preferably 1 to 5,

Examples of the monomer which provides the structural unit (III) include terephthalic acid (TPA, formula (7) below), isophthalic acid (IPA, formula (8) below), 2,6-naphthalenedicarboxylic acid (NADA, formula (9) below), and acyl derivatives, ester derivatives, acid halides thereof, and the like.

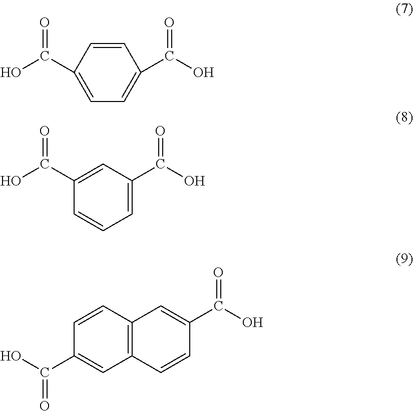

The composition ratio (mol %) of the structural unit (III) based on the total structural units of the entire polyester resin (A) has a lower limit of preferably 10 mol % or more, more preferably 12.5 mol % or more, further preferably 15 mol % or more, further more preferably 17.5 mol % or more, and an upper limit of preferably 35 mol % or less, more preferably 32.5 mol % or less, further preferably 30 mol % or less, further more preferably 27.5 mol % or less. When two or more of structural units (II) are contained, the total molar ratio thereof may be within the ranges of the above composition ratio. The composition ratio of the structural unit (II) and the composition ratio of the structural unit (III) are substantially equivalent ((structural unit (II)≈structural unit (III)).

The liquid crystal properties of the liquid crystal polyester resin (A) can be confirmed by heating and melting the liquid crystal polyester resin (A) on a microscope heating stage using a polarizing microscope (product name: BH-2) manufactured by Olympus Co., Ltd. having a hot stage (product name: FP82HT) for microscopes manufactured by Mettler, and then observing whether or not optical anisotropy can be seen.

The lower limit of the melting point of the liquid crystal polyester resin (A) is preferably 280° C. or higher, more preferably 290° C. or higher, further preferably 300° C. or higher, and further more preferably 305° C. or higher. The upper limit is preferably 370° C. or less, preferably 360° C. or less, further preferably 355° C. or less, and further more preferably 350° C. or less. By setting the melting point of the liquid crystal polyester resin (A) within the above numerical ranges, it is possible to improve the processing stability of the resin composition containing the liquid crystal polyester resin (A) within the range shown in the present invention, specifically, the stability of melt processing properties when being subjected to shear and melt processing stability when shear is not applied, and also it is possible to maintain the heat resistance as a material of a molded article produced by using the resin composition in a favorable range from the viewpoint of solder heat resistance.

In view of securing melt moldability and heat resistance, the melt viscosity of the liquid crystal polyester resin (A) has a lower limit of preferably 5 Pa·s or more and an upper limit of preferably 130 Pa·s or less, more preferably 100 Pa·s, further preferably 70 Pa·s or less, and further more preferably 50 Pa·s or less, under the conditions of the melting point of the liquid crystal polyester resin+20° C. or higher and the shear rate of 1000 s⁻¹.

The dielectric loss tangent of the liquid crystal polyester resin (A) (measurement frequency: 10 GHz) is 1.00×10⁻³ or less, preferably 0.95×10⁻³ or less, more preferably 0.90×10⁻³ or less, and further preferably 0.85×10⁻³ or less. This value is a measured value of the dielectric loss tangent of the injection molded product of the liquid crystal polyester resin (A) in the in-plane direction, Note that, the injection molded product is a flat plate test piece of 30 mm×30 mm×0.4 mm (thickness).

Permittivity of the liquid crystal polyester resin (A) measured by the SPAR method at 10 GHz is 3.7 or less and preferably 3.6 or less.

### (Method for Producing Liquid Crystal Polyester Resin (A))

The liquid crystal polyester resin (A) can be produced by polymerizing a monomer, which optionally provides structural units (I) to (III), by a known method. In one embodiment, the wholly aromatic liquid crystal polyester resin according to the present invention can also be produced by two-step polymerization in which a prepolymer prepared by melt polymerization is then further subjected to solid-phase polymerization.

From the viewpoint of efficiently obtaining the polyester compound according to the present invention, the melt polymerization is preferably carried out under acetic acid reflux in the presence of acetic anhydride in an amount of 1.05 to 1.15 molar equivalents with respect to all the hydroxyl groups contained in the monomer, with the monomer providing the above structural units (I) to (III) added up to a total of 100 mol % in a predetermined combination.

In the case where the polymerization reaction is carried out in two steps of the melt polymerization and the subsequent solid phase polymerization, the prepolymer obtained by the melt polymerization is cooled and solidified, pulverized into powder or flakes, and subsequently a known solid phase polymerization method is preferably employed, for example, a method in which the prepolymer resin is heat-treated in an inert atmosphere such as nitrogen or under vacuum at a temperature of 200 to 350° C. for 1 to 30 hours. The solid phase polymerization may be carried out while stirring, or may be carried out in a still standing state without stirring.

A catalyst can be used or need not be used in the polymerization reaction. The catalyst to be used may be conventionally known catalysts as catalysts for polymerization of polyesters, examples thereof being metal salt catalysts such as magnesium acetate, stannous acetate, tetrabutyl titanate, lead acetate, sodium acetate, potassium acetate, and antimony trioxide, nitrogen-containing heterocyclic compounds such as N-methylimidazole, organic compound catalysts, and the like. The amount of the catalyst used is not particularly limited, and is preferably 0.0001 to 0.1 part by weight based on 100 parts by weight of the total amount of the monomer.

The polymerization reaction apparatus in the melt polymerization is not particularly limited, and preferably a reaction apparatus used for the reaction of a general high viscosity fluid is used. Examples of these reaction apparatuses include, for example, an stirring tank type polymerization apparatus having an stirring blade of an anchor type, a multistage type, a spiral band type, a spiral shaft type or the like, or a variety of shapes obtained by modifying these types, mixing apparatuses generally used for kneading resins such as a kneader, a roll mill, and a Banbury mixer.

### (Fluorine Resin (B))

The fluorine resin (B) is not particularly limited, and examples thereof include polytetrafluoroethylene resin (PTFE), tetrafluoroethylene-perfluoroalkyl vinyl ether copolymer resin (PFA), tetrafluoroethylene-hexafluoropropylene copolymer resin (FEP), polychlorotrifluoroethylene resin (PCTFE), ethylene-tetrafluoroethylene copolymer resin (ETFE), ethylene-chlorotrifluoroethylene copolymer resin (ECTFE), polyvinylidene fluoride resin (PVDF), polyvinyl fluoride resin (PVF), tetrafluoroethylene-perfluoroalkyl vinyl ether-hexafluoropropylene copolymer resin (EPE), and the like. Among them, polytetrafluoroethylene resin (PTFE) is preferably used. Only one of the fluorine resin (B) may be used, or two or more kinds are also possible.

The amount of the liquid crystal polyester resin (A) blended in the resin composition according to the present invention is, as the lowest limit, preferably 30 parts by mass or more, more preferably 40 parts by mass or more, further preferably 45 parts by mass or more, further more preferably 50 parts by mass or more, and as the upper limit is preferably 95 parts by mass or less, more preferably 90 parts by mass or less, further preferably 85 parts by mass or less, and further more preferably 80 parts by mass or less, based on 100 parts by mass of the total of the liquid crystal polyester resin (A) and the fluorine resin (B), The amount of the fluorine resin (B) blended is, as the lower limit, preferably 5 parts by mass or more, more preferably 10 parts by mass or more, further preferably 15 parts by mass or more, further more preferably 20 part by mass or more, and as the upper limit, preferably 70 parts by mass or less, more preferably 60 parts by mass or less, further preferably 55 parts by mass or less, further more preferably 50 parts by mass or less, based on 100 parts by mass of the total of the liquid crystal polyester resin (A) and the fluorine resin (B), When the blending ratio of the liquid crystal polyester resin (A) and the fluorine resin (B) is about in the above-described numerical ranges, it is possible to obtain a resin composition having better processability and heat resistance while having low dielectric loss tangent and low permittivity.

The resin composition according to the present invention may include other additives such as a colorant, a dispersant, a plasticizer, an antioxidant, a curing agent, a flame retardant, a thermal stabilizer, an ultraviolet absorber, an antistatic agent, and a surfactant, as long as the effect of the present invention is not impaired.

### (Resin Molded Article)

A resin molded article according to the present invention comprises the resin composition described above. A resin molded article according to the present invention has low dielectric loss tangent and low permittivity, while being excellent in heat resistance.

The lower limit of practical heat resistant temperature of the resin molded article is preferably 250° C. or higher, more preferably 270° C. or higher, and further preferably 280° C. or higher.

In the present specification, the practical heat resistant temperature of the resin molded article is a temperature measured as follows. Firstly, the resin molded article (a flat plate test piece) is cut into 30 mm×8 mm (the longer side is in the TD direction) to obtain a sample for measurement. The obtained sample is evaluated for the practical heat-resistance by using a dynamic viscoelastic device (DMA, manufactured by Hitachi High-Tech Science K.K., type no. DMS6100). Specifically, measurement is done at 1 Hz, temperature increasing rate 6° C./min, and a measurement starting temperature of 30° C., and the point where the sample deformed or broke an elastically by heat was determined the measurement end point. In the measured data, on or after 200° C. in the graph of loss elastic modulus, the cross point of each of the tangent lines of the flat portion and the portion right before the measurement ends is calculated, and the temperature of the cross point is determined as the practical heat resistant temperature of which the material yields to the stress of the DMA device and breaks.

The dielectric tangent of the resin molded article after the heat treatment, measured by the SPDR method is 0.70×10⁻³ or less, preferably 0.65×10⁻³ or less, more preferably 0.60×10⁻³ or less, and further preferably 0.55×10⁻³ or less. This value of the dielectric tangent is the value measured in the similar way as the measurement method of the dielectric tangent of the resin composition mentioned above.

The relative permittivity of the resin molded article after the heat treatment is preferably 3.5 or less, preferably 3.4 or less, more preferably 3.3 or less, and further preferably 3.2 or less. The value of the relative permittivity is obtained by the above-described formula (1) in the similar way as the measurement method of the relative permittivity of the resin composition.

The resin molded article preferably has a water absorption rate measured according to ASTM D570 of 0,04% or less, more preferably 0.03% or less, and further preferably 0.02% or less. The water absorption rate is a value obtained by measuring the weight of the test piece in a dry state and the weight of the test piece after immersing the test piece in water for 24 hours, and measuring the weight increase rate therefrom. By the resin molded article having a low water absorption rate, the resin molded article can stably exhibit the low dielectric properties even in actual use.

### (Method for Manufacturing Resin Molded Article)

In the present invention, a resin composition comprising the above-described liquid crystal polyester resin (A) and the fluorine resin (B), and optionally an additive can be obtained by molding by a conventionally known method. The resin composition can be obtained by melt-kneading the wholly liquid crystal polyester resin (A) and the fluorine resin (B) using a Banbury mixer, a kneader, a uniaxial or biaxial extruder, and the like.

Examples of the molding method include press molding, foam molding, injection molding, extrusion molding, and punch molding. The molded article produced as described above can be processed into various shapes depending on the application. The shape of the molded article may be, for example, a plate shape or a film shape.

In the present invention, the dielectric loss tangent can be further reduced by further performing a heat treatment (annealing) on the obtained resin molded article. The lower limit of the temperature of the heat treatment (annealing) is preferably “Tm₂−50° C.” or higher, more preferably “Tm₂−40° C.” or higher, further preferably “Tm₂−30° C.” or higher, further more preferably “Tm₂−20° C.” or higher, and the upper limit is preferably “Tm₂+10° C.” or lower, more preferably “Tm₂+5° C.” or lower, further preferably “Tm₂” or lower, further more preferably “Tm₂−5° C.” or lower. Further, for example, the lower limit of the heat treatment time is preferably 30 minutes or more, 1 hour or more, more preferably 2 hours or more, and the upper limit is preferably 10 hours or less, more preferably 5 hours or less. The heating atmosphere is preferably under an atmospheric environment, more preferably under reduced pressure, and further preferably under a nitrogen atmosphere. When the heating temperature, time, and atmosphere are within the above ranges, the dielectric loss tangent of the resin molded article can be further reduced.

### (Electric/Electronic Component)

An electric/electronic component according to the present invention comprises the resin composition. Examples of the electric/electronic component include antennas used for electronic instruments and communication instruments such as ETC, GPS, wireless LAN, and mobile phones; connectors for high-speed transmission; CPU sockets; circuit boards; flexible printed circuit boards (FPCs); multilayer circuit boards; millimeter and quasi-millimeter wave radars such as collision prevention radars; RFID tags; condensers; inverter components; insulating films; cable covering materials; insulating materials for secondary batteries such as lithium ion batteries; speaker diaphragms; and the like.

### EXAMPLES

Hereinafter, the present invention will be described more specifically with reference to the Examples; however, the present invention shall not be limited to the Examples,

### [Test 1]

The following tests were conducted to confirm that a resin composition can be produced in which a specific liquid crystal polyester resin is blended with a fluorine resin and that the obtained resin composition can maintain low viscosity in a high shear region and can maintain processability.

### Production of Liquid Crystal Polyester Resin (A)

### Synthesis Example 1

To a polymerization vessel having a stirring blade, 50 mol % of 6-hydroxy-2-naphthoic acid (HNA), 25 mol % of 4,4′-dihydroxybiphenyl (BP), 17 mol % of terephthalic acid (TPA), and 8 mol % of 2,6-naphthalenedicarboxylic acid (NADA) were added, then potassium acetate and magnesium acetate were charged as catalysts, and after nitrogen substitution by carrying out pressure reduction—nitrogen injection of the polymerization vessel for three times, acetic anhydride (1.08 mol equivalent based on hydroxyl group) was further added, the temperature was raised to 150° C., and acetylation reaction was carried out for 2 hours under reflux.

After completion of acetylation, the temperature of the polymerization vessel in a state where the acetic add is distilled out was raised at 0.5° C./min, and when the temperature of the melt in the vessel reached 310° C., the polymer was extracted and cooled and solidified. The obtained polymer was pulverized to a size passing through a sieve having a mesh opening of 2.0 mm, thereby giving a prepolymer.

Next, the prepolymer obtained above was heated from room temperature to 300° C. for 14 hours with a heater in an oven manufactured by Yamato Scientific Co., Ltd., and then solid phase polymerization was carried out while maintaining the temperature at 300° C. for 2 hours, Thereafter, heat was naturally released at room temperature to obtain a liquid crystal polyester resin A1, By using a polarizing microscope (product name: BH-2) made by Olympus Co., Ltd. equipped with a hot stage for a microscope (product name: FP82HT) manufactured by Mettler, the liquid crystal polyester resin sample was heated and melted on the microscope heating stage, and it was confirmed that liquid crystal properties were exhibited from the presence or absence of optical anisotropy.

### Synthesis Example 2

A liquid crystal polyester resin A2 was obtained in the same manner as in Synthesis Example 1 except that the monomer feed was changed to 60 mol % of HNA, 20 mol % of BP, 15.5 mol % of TPA, and 4.5 mol % of NADA, and the final temperature of solid phase polymerization was changed to 295° C. and the holding time was changed to 1 hour. Subsequently, it was confirmed that the obtained liquid crystal polyester resin A2 exhibits liquid crystal properties in the same manner as described above.

### Synthesis Example 3

A liquid crystal polyester resin A3 was obtained in the same manner as in Synthesis Example 1 except that the monomer feed was changed to 50 mol % of HNA, 25 mol % of BP, 22 mol % of TPA, and 3 mol % of isophthalic add (IPA) and the final temperature of the solid phase polymerization was changed to 310° C. Subsequently, it was confirmed that the obtained liquid crystal polyester resin A3 exhibits liquid crystal properties in the same manner as described above.

### Synthesis Example 4

The monomer feed was changed to 27 mol % of HNA and 73 mol % of p-hydroxybenzoic add (HBA), acetylation was performed in the same manner, and the temperature was raised to 360° C. over 5 hours and 30 minutes. Thereafter, the pressure was reduced to 10 torr over 20 minutes, whereupon the polymer was removed and cooled to solidify. Thereafter, the polymer was cooled to solidify. The polymer thus obtained was pulverized to a size passing through a sieve having an opening of 2.0 mm, thereby obtaining a liquid crystalline polyester resin A4 without conducting solid-phase polymerization. Subsequently, it was confirmed that the liquid crystalline polyester resin A4 thus obtained exhibited liquid crystallinity in the same manner as described above.

### Synthesis Example 5

A liquid crystal polyester resin A5 was obtained in the same manner as Synthesis Example 1 except that the monomer feed was changed to 60 mol % of HBA, 20 mol % of BP, 15 mol % of TPA, and 5 mol % of IPA, and the holding time at 300° C. was changed to 1 hour. Subsequently, it was confirmed that the obtained liquid crystal polyester resin A5 showed liquid crystallinity in the same manner as described above.

The structural units (monomer compositions) of the liquid crystal polyester resins A1 to A5 obtained above are shown in Table 1.

### (Measurement of Melting Point)

The melting points of the liquid crystal polyester resins A1 to A5 obtained above were measured by a differential scanning calorimeter (DSC) manufactured by Hitachi High-Tech Science Co., Ltd. according to the test methods of ISO11357, ASTM D3418. At this time, the endothermic peak obtained by raising the temperature from room temperature to 360-380° C. at a temperature elevation rate of 10° C./min to completely fuse the polymer, and then lowering the temperature to 30° C. at a rate of 10° C./min, and then further raising the temperature to 380° C. at a rate of 10° C./min was determined as the melting point (Tm₂). The measurement results are shown in Table 1.

### (Melt Viscosity Measurement)

With respect to the liquid crystal polyester resins A1 to A5 obtained above, the melt viscosity (Pa·s) at the melting point+20° C. at a shear rate of 1000 S⁻¹ was measured using a capillary rheometer viscometer (Capillograph 1D, Toyo Seiki Seisaku-sho, Ltd.) and a capillary having an inner diameter of 1 mm, in accordance with JIS K7199. The measurement results are shown in Table 1. Note that, before the measurement, the resin compositions were dried under reduced pressure at 150° C. for 4 hours.

### (Dielectric Loss Tangent and Relative Permittivity Measurement (10 GHz))

The liquid crystal polyester resins A1 to A5 obtained above were heated and melted under the conditions of each melting point to melting point+30° C., and injection molding was performed using a mold of 30 mm×30 mm×0.4 mm (thickness) to prepare flat test pieces, Subsequently, using the flat test pieces, relative permittivity and dielectric loss tangent in the in-plane direction at a frequency of 10 GHz were measured by the split-post dielectric resonator method (SPDR method) using the network analyzer N5247A of Keysight Technologies. Samples of each kind were measured by N=4 each, and the average of the four measurements are shown in Table 1.

TABLE 1

| | Liquid | Compositions (mol %) | | | | | | | | Dielectric | |
|---|---|---|---|---|---|---|---|---|---|---|---|
| | Crystal | Structural Unit | | Structural | Structural Unit | | | Melting | Melt | loss tangent | Relative |
| | Polyester | (I) | | Unit (II) | (III) | | | Point | Viscosity | tanδ | Permittivity |
| | Resins (A) | HNA | HBA | BP | TPA | NADA | IPA | (° C.) | (Pa · s) | (×10⁻³) | Er |
| Synthesis | A1 | 50 | — | 25 | 17 | 8 | — | 310 | 36 | 0.67 | 3.56 |
| Example 1 | | | | | | | | | | | |
| Synthesis | A2 | 60 | — | 20 | 15.5 | 4.5 | — | 319 | 15 | 0.62 | 3.57 |
| Example 2 | | | | | | | | | | | |
| Synthesis | A3 | 50 | — | 25 | 22 | — | 3 | 350 | 16 | 0.85 | 3.57 |
| Example 3 | | | | | | | | | | | |
| Synthesis | A4 | 27 | 73 | — | — | — | — | 275 | 51 | 1.77 | 3.51 |
| Example 4 | | | | | | | | | | | |
| Synthesis | A5 | — | 60 | 20 | 15 | — | 5 | 355 | 36 | 2.24 | 3.48 |
| Example 5 | | | | | | | | | | | |

### <Preparation of Fluorine Resin (B)>

The following resin was prepared as the fluorine resin (B).
Polytetrafluoroethylene resin (PTFE): manufactured by Kitamura Co., Ltd., product name: KT-400M

### <Preparation of Another Mixture>

The following hollow glass was prepared as another mixture.
Hollow glass (manufactured by 3M, product name: S-60HS, average particle diameter: 30 μm, true specific gravity: 0.60 g/cm³)

### Production of Resin Composition

### Example 1-1

95 parts by mass of the liquid crystal polyester resin A1 obtained above and 5 parts by mass of the above-described polytetrafluoroethylene resin were dry-blended, then kneaded with a two axis kneader (Laboplast Mill Micro 2D15 W, manufactured by Toyo Seiki Seisaku-sho, Ltd.) at a temperature of Tm2 of the liquid crystal polyester resin A1+30 to 50° C., strand cut, and pelletized to obtain a pelletized resin composition. Liquid crystallinity of the obtained resin composition was confirmed in the same manner as described above, and liquid crystallinity was confirmed in the melted liquid crystalline polyester resin portion.

### Example 1-2

A pellet-form resin composition was produced in the same manner as in Example 1, except that 90 parts by mass of the liquid crystal polyester resin A1 obtained above and 10 parts by mass of the polytetrafluoroethylene resin were kneaded. When liquid crystallinity was confirmed in the same manner as described above, liquid crystallinity was confirmed in the melted liquid crystal polyester resin portion.

### Example 1-3

A pellet-form resin composition was produced in the same manner as in Example 1, except that 80 parts by mass of the liquid crystal polyester resin A1 obtained above and 20 parts by mass of the polytetrafluoroethylene resin were kneaded. When liquid crystallinity was confirmed in the same manner as described above, liquid crystallinity was confirmed in the melted liquid crystal polyester resin portion.

### Example 1-4

A pellet-form resin composition was produced in the same manner as in Example 1, except that 70 parts by mass of the liquid crystal polyester resin A1 obtained above and 30 parts by mass of the polytetrafluoroethylene resin were kneaded. When liquid crystallinity was confirmed in the same manner as described above, liquid crystallinity was confirmed in the melted liquid crystal polyester resin portion.

### Example 1-5

A pellet-form resin composition was produced in the same manner as in Example 1, except that 50 parts by mass of the liquid crystal polyester resin A1 obtained above and 50 parts by mass of the polytetrafluoroethylene resin were kneaded. When liquid crystallinity was confirmed in the same manner as described above, liquid crystallinity was confirmed in the melted liquid crystal polyester resin portion.

### Example 1-6

A pellet-form resin composition was produced in the same manner as in Example 1, except that 40 parts by mass of the liquid crystal polyester resin A1 obtained above and 60 parts by mass of the polytetrafluoroethylene resin were kneaded. When liquid crystallinity was confirmed in the same manner as described above, liquid crystallinity was confirmed in the melted liquid crystal polyester resin portion.

### Example 1-7

A pellet-form resin composition was produced in the same manner as in Example 1, except that 30 parts by mass of the liquid crystal polyester resin A1 obtained above and 70 parts by mass of the polytetrafluoroethylene resin were kneaded. When liquid crystallinity was confirmed in the same manner as described above, liquid crystallinity was confirmed in the melted liquid crystal polyester resin portion.

### Example 2-1

A pellet-form resin composition was produced in the same manner as in Example 1, except that 90 parts by mass of the liquid crystal polyester resin A2 obtained above and 10 parts by mass of the polytetrafluoroethylene resin were kneaded. When liquid crystallinity was confirmed in the same manner as described above, liquid crystallinity was confirmed in the melted liquid crystal polyester resin portion.

### Example 2-2

A pellet-form resin composition was produced in the same manner as in Example 1, except that 80 parts by mass of the liquid crystal polyester resin A2 obtained above and 20 parts by mass of the polytetrafluoroethylene resin were kneaded. When liquid crystallinity was confirmed in the same manner as described above, liquid crystallinity was confirmed in the melted liquid crystal polyester resin portion.

### Example 2-3

A pellet-form resin composition was produced in the same manner as in Example 1, except that 70 parts by mass of the liquid crystal polyester resin A2 obtained above and 30 parts by mass of the polytetrafluoroethylene resin were kneaded. When liquid crystallinity was confirmed in the same manner as described above, liquid crystallinity was confirmed in the melted liquid crystal polyester resin portion.

### Example 2-4

A pellet-form resin composition was produced in the same manner as in Example 1, except that 50 parts by mass of the liquid crystal polyester resin A2 obtained above and 50 parts by mass of the polytetrafluoroethylene resin were kneaded. When liquid crystallinity was confirmed in the same manner as described above, liquid crystallinity was confirmed in the melted liquid crystal polyester resin portion.

### Example 2-5

A pellet-form resin composition was produced in the same manner as in Example 1, except that 40 parts by mass of the liquid crystal polyester resin A2 obtained above and 60 parts by mass of the polytetrafluoroethylene resin were kneaded. When liquid crystallinity was confirmed in the same manner as described above, liquid crystallinity was confirmed in the melted liquid crystal polyester resin portion.

### Example 3-1

A pellet-form resin composition was produced in the same manner as in Example 1, except that 70 parts by mass of the liquid crystal polyester resin A3 obtained above and 30 parts by mass of the polytetrafluoroethylene resin were kneaded. When liquid crystallinity was confirmed in the same manner as described above, liquid crystallinity was confirmed in the melted liquid crystal polyester resin portion.

### Example 3-2

A pellet-form resin composition was produced in the same manner as in Example 1, except that 50 parts by mass of the liquid crystal polyester resin A3 obtained above and 50 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 1-1

A pellet-form resin composition was produced in the same manner as in Example 1, except that 90 parts by mass of the liquid crystal polyester resin A4 obtained above and 10 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 1-2

A pellet-form resin composition was produced in the same manner as in Example 1, except that 70 parts by mass of the liquid crystal polyester resin A4 obtained above and 30 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 1-3

A pellet-form resin composition was produced in the same manner as in Example 1, except that 50 parts by mass of the liquid crystal polyester resin A4 obtained above and 50 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 1-4

A pellet-form resin composition was produced in the same manner as in Example 1, except that 30 parts by mass of the liquid crystal polyester resin A4 obtained above and 70 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 2-1

A pellet-form resin composition was produced in the same manner as in Example 1, except that 90 parts by mass of the liquid crystal polyester resin A5 obtained above and 10 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 2-2

A pellet-form resin composition was produced in the same manner as in Example 1, except that 70 parts by mass of the liquid crystal polyester resin A5 obtained above and 30 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 2-3

A pellet-form resin composition was produced in the same manner as in Example 1, except that 50 parts by mass of the liquid crystal polyester resin A5 obtained above and 50 parts by mass of the polytetrafluoroethylene resin were kneaded. When liquid crystallinity was confirmed in the same manner as described above, liquid crystallinity was confirmed in the melted liquid crystal polyester resin portion.

### Comparative Example 3-1

A pellet-form resin composition was produced in the same manner as in Example 1 except that 90 parts by mass of the liquid crystal polyester resin A1 obtained above and 10 parts by mass of hollow glass were kneaded. When liquid crystallinity was confirmed in the same manner as described above, liquid crystallinity was confirmed in the melted liquid crystal polyester resin portion.

### Comparative Example 3-2

A pelletized resin composition was produced in the same manner as in Example 1, except that 70 parts by mass of the liquid crystal polyester resin A1 obtained above and 30 parts by mass of hollow glass were kneaded. When liquid crystallinity was confirmed in the same manner as described above, liquid crystallinity was confirmed in the melted liquid crystal polyester resin portion.

### Comparative Example 3-3

A pellet-form resin composition was produced in the same manner as in Example 1 except that 50 parts by mass of the liquid crystal polyester resin A1 obtained above and 50 parts by mass of hollow glass were kneaded. When liquid crystallinity was confirmed in the same manner as described above, liquid crystallinity was confirmed in the melted liquid crystal polyester resin portion.

The compositions of the resin compositions obtained above are shown in Table 2.

### (Measurement of Melting Point)

The melting points of the resin compositions obtained in the above Examples and Comparative Examples were measured by a differential scanning calorimeter (DSC) manufactured by Hitachi High-Technology Science Co., Ltd, in accordance with the test method of ISO11357, ASTM D3418. At this time, the peak of the endothermic peak derived from the liquid crystal polyester resin was defined as the melting point (Tm₂) which can be obtained by increasing the temperature from room temperature to 360-380° C. at a temperature increasing rate of 10° C./min to completely melt the polymer, then lowering the temperature to 30° C. at a rate of 10° C./min, and further increasing the temperature to 380° C. at a rate of 10° C./min. The measurement results are shown in Table 2 below.

### (Measurement of Melt Viscosity)

The melt viscosity (Pa's) of the resin compositions obtained in the above Examples and Comparative Examples at a shear rate of 1000 S⁻¹ at a temperature equal to or higher than the melting point of the liquid crystalline polyester resin (A)+20° C. was measured in accordance with JIS K7199 using a capillary rheometer viscometer (Capirograph 1D, Toyo Seiki Seisaku-sho, Ltd.) and a capillary having an inner diameter of 1 mm. The measurement results are shown in Table 2, Before the measurement, the resin compositions were dried under reduced pressure at 150° C. for 4 hours.

The ratios of the melt viscosity of the resin compositions compared with the melt viscosity of the liquid crystalline polyester resins (melt viscosity of the resin composition/melt viscosity of the liquid crystalline polyester resin) (%) are shown in Table 2.

TABLE 2

| | Liquid Crystal | | | | Measurement | | |
|---|---|---|---|---|---|---|---|
| | Polyester Resin | | | | Temperature | | Ratio of |
| | (A) | | Another Mixture | | of Melt | Melt | Melt |
| | | Amount | | Amount | Viscosity | Viscosity | viscosity |
| | Type | (w %) | Type | (w %) | (° C.) | (Pa · s) | (%) |
| Example 1-1 | A1 | 95 | PTFE | 5 | 340 | 23 | 64 |
| Example 1-2 | A1 | 90 | PTFE | 10 | 340 | 47 | 132 |
| Example 1-3 | A1 | 80 | PTFE | 20 | 340 | 37 | 101 |
| Example 1-4 | A1 | 70 | PTFE | 30 | 340 | 68 | 189 |
| Example 1-5 | A1 | 50 | PTFE | 50 | 340 | 128 | 355 |
| Example 1-6 | A1 | 40 | PTFE | 60 | 340 | 157 | 435 |
| Example 1-7 | A1 | 30 | PTFE | 70 | 340 | 210 | 583 |
| Example 2-1 | A2 | 90 | PTFE | 10 | 340 | 15 | 102 |
| Example 2-2 | A2 | 80 | PTFE | 20 | 340 | 59 | 393 |
| Example 2-3 | A2 | 70 | PTFE | 30 | 340 | 36 | 241 |
| Example 2-4 | A2 | 50 | PTFE | 50 | 340 | 73 | 485 |
| Example 2-5 | A2 | 40 | PTFE | 60 | 340 | 233 | 1547 |
| Example 3-1 | A3 | 70 | PTFE | 30 | 375 | 37 | 233 |
| Example 3-2 | A3 | 50 | PTFE | 50 | 375 | 75 | 470 |
| Comparative | A4 | 90 | PTFE | 10 | 295 | 54 | 104 |
| Example 1-1 | | | | | | | |
| Comparative | A4 | 70 | PTFE | 30 | 295 | 86 | 168 |
| Example 1-2 | | | | | | | |
| Comparative | A4 | 50 | PTFE | 50 | 295 | 139 | 271 |
| Example 1-3 | | | | | | | |
| Comparative | A4 | 30 | PTFE | 70 | 295 | 533 | 1037 |
| Example 1-4 | | | | | | | |
| Comparative | A5 | 90 | PTFE | 10 | 375 | 35 | 99 |
| Example 2-1 | | | | | | | |
| Comparative | A5 | 70 | PTFE | 30 | 375 | 64 | 177 |
| Example 2-2 | | | | | | | |
| Comparative | A5 | 50 | PTFE | 50 | 375 | 121 | 339 |
| Example 2-3 | | | | | | | |
| Comparative | A1 | 90 | Hollow | 10 | 340 | 50 | 139 |
| Exampie 3-1 | | | Glass | | | | |
| Comparative | A1 | 70 | Hollow | 30 | 340 | 207 | 573 |
| Example 3-2 | | | Glass | | | | |
| Comparative | A1 | 50 | Hollow | 50 | 340 | 681 | 1890 |
| Example 3-3 | | | Glass | | | | |

From the results in Table 2, it was confirmed that the viscosity increased in accordance with the amount of the fluorine resin blended in the resin composition. Although the manner in which the viscosity increased differed depending on the type of the liquid crystal polyester resin and the combination of the fluorine resin, the melt viscosity was 250 Pa·s or less at the maximum for the compositions of the Examples and it was confirmed that the processability could be maintained.

When comparing Examples 1-1 to 1-7 in which the liquid crystal polyester resin A1 was blended with the fluorine resin and Comparative Examples 3-1 to 3-3 in which the same liquid crystal polyester resin A1 was blended with the hollow glass, it was confirmed that the degree of increase in viscosity was higher when the hollow glass was blended, and that the low viscosity in the high shear region was impaired, which is an excellent feature of a liquid crystal polyester resin.

### [Test 2]

The following tests were conducted in order to confirm that a resin molded article can be produced using the resin compositions obtained in Test 1 and that these resin compositions have low dielectric loss tangent and low permittivity while being excellent in processability.

### <Manufacturing of Resin Molded Article 1>

The pellet-form resin compositions obtained in the above Examples and Comparative Examples were heated and melted by using a small-sized injection molding machine under the condition of melting point to melting point+30° C., and injection molded using a mold of 30 mm×30 mm×0.4 mm (thickness) or 30 mm×30 mm×0.8 mm (thickness) to prepare flat test pieces. When the melt viscosity of the resin composition was 150 Pa·s or less, the flat test piece was molded 0.4 mm thick and when the melt viscosity of the resin composition was higher (more than 150 Pa·s), the flat test piece was molded 0.8 mm thick. On the other hand, when the melt viscosity of the resin composition was even higher (more than 250 Pa's), the mold could not be filled with the resin composition, and a complete molded article could not be obtained,

### <Performance Evaluation 1>

### <Measurement of Dielectric Loss Tangent and Relative Permittivity (10 GHz)>

Using the flat plate test pieces produced above and using a network analyzer N5247A of Keysight Technologies, relative permittivity and dielectric loss tangent in the in-plane direction at a frequency of 10 GHz were measured by the split post dielectric resonator method (SPDR method). Each type of samples were measured for N=4 times each, and the average values of the four measurements are shown in Table 3.

### <Calculation of Dielectric Loss Factor F>

Measured relative permittivity Er and dielectric loss tangent tan δ were applied to the above described equation (2) to calculate dielectric loss factor F, which is shown in Table 3. The smaller the value of the dielectric loss factor F, the occurrence of dielectric loss is expected to be smaller when a circuit board is made of the inventive material.

TABLE 3

| | | Performance Evaluation | | |
|---|---|---|---|---|
| | | Dielectric | | |
| | Thickness | Loss | | Dielectric |
| | of Molded | Tangent | Relative | Loss |
| | Article | tanδ | Permittivity | Factor |
| | (mm) | (× 10⁻³) | Er | F |
| Example 1-1 | 0.4 | 0.78 | 3.43 | 1.4 |
| Example 1-2 | 0.4 | 0.70 | 3.45 | 1.3 |
| Example 1-3 | 0.4 | 0.63 | 3.32 | 1.1 |
| Example 1-4 | 0.4 | 0.66 | 3.22 | 1.2 |
| Example 1-5 | 0.4 | 0.60 | 2.95 | 1.0 |
| Example 1-6 | 0.8 | 0.58 | 2.79 | 1.0 |
| Example 1-7 | 0.8 | 0.48 | 2.60 | 0.8 |
| Example 2-1 | 0.4 | 0.73 | 3.45 | 1.4 |
| Example 2-2 | 0.4 | 0.68 | 3.33 | 1.2 |
| Example 2-3 | 0.4 | 0.71 | 3.19 | 1.3 |
| Example 2-4 | 0.4 | 0.62 | 2.95 | 1.1 |
| Example 2-5 | 0.8 | 0.53 | 2.77 | 0.9 |
| Example 3-1 | 0.4 | 0.80 | 3.17 | 1.4 |
| Example 3-2 | 0.4 | 0.75 | 2.88 | 1.3 |
| Comparative | 0.4 | 1.90 | 3.36 | 3.5 |
| Example 1-1 | | | | |
| Comparative | 0.4 | 1.60 | 3.14 | 2.8 |
| Example 1-2 | | | | |
| Comparative | 0.4 | 1.30 | 2.91 | 2.2 |
| Example 1-3 | | | | |
| Comparative | 0.4 | 2.54 | 3.35 | 4.6 |
| Example 2-1 | | | | |
| Comparative | 0.4 | 2.28 | 3.15 | 4.0 |
| Example 2-2 | | | | |
| Comparative | 0.4 | 1.90 | 2.88 | 3.2 |
| Example 2-3 | | | | |
| Comparative | 0.4 | 1.49 | 3.39 | 2.7 |
| Example 3-1 | | | | |
| Comparative | 0.8 | 3.15 | 3.16 | 5.6 |
| Example 3-2 | | | | |

It has been confirmed that the resin composition of the present invention has low dielectric loss tangent and low permittivity while being excellent in processability. Specifically, the resin compositions of Examples 1-1 to 3-2 have extremely low dielectric loss tangent (tan δ) and nearly half the dielectric loss factor F as compared with the resin compositions of Comparative Examples 1-1 to 2-3 containing fluorine resins, and thus have shown the possibility of reducing by half the dielectric loss when used in a circuit board as compared with the Comparative Examples. Therefore, it was confirmed that the resin compositions of Examples 1-1 to 3-2 were materials capable of greatly suppressing the dielectric loss.

In addition, the resin compositions of Examples 1-1 to 1-7 showed lower values of permittivity corresponding to the amount of the fluorine resin blended compared with Comparative Examples 3-1 to 3-2 containing hollow glass, but showed extremely low values of dielectric loss tangent (tan δ). On the other hand, in Comparative Examples 3-1 to 3-2, the values of dielectric loss tangent (tan δ) increased and deteriorated according to the amount of the hollow glass added to the resin composition. On the other hand, in Comparative Examples 3-1 to 3-2, the values of dielectric loss tangent (tan δ) increased and deteriorated according to the amount of the hollow glass blended into the resin composition.

According to the foregoing, it was confirmed that in order to obtain a resin composition having a low dielectric loss tangent and a low permittivity while having excellent processability, a combination of a specific liquid crystal polyester resin and a fluorine resin is important.

### [Test 3]

The following tests were carried out using the plate test pieces as like in Test 2, for the purpose of evaluating the dielectric characteristics in the thickness direction.

### <Performance Evaluation 2>

### <Dielectric Loss Tangent/Relative Permittivity Measurement (10 GHz)>

The flat plate test pieces produced in Test 2 above were measured for relative permittivity and dielectric loss tangent in the thickness direction at a frequency of 10 GHz by a cylindrical cavity resonator method. Each type of samples was measured for N=4 times each, and the average values of four measurements are shown in Table 4.

### <Calculation of Dielectric Loss Factor F>

In the same manner as in <Performance Evaluation 1> above, dielectric loss factor F in the thickness direction was calculated using the above equation (2), and the values were shown in Table 4.

TABLE 4

| | Performance Evaluation | | |
|---|---|---|---|
| | Dielectric | | |
| | Loss | | Dielectric |
| | Tangent | Relative | Loss |
| | tanδ | Permittivity | Factor |
| | (× 10⁻³) | Er | F |
| Example 1-4 | 1.6 | 2.88 | 2.72 |
| Example 1-5 | 1.0 | 2.73 | 2.31 |
| Example 2-3 | 1.7 | 2.93 | 2.91 |
| Example 2-4 | 1.4 | 2.73 | 2.31 |
| Comparative | 2.4 | 2.91 | 4.09 |
| Example 1-2 | | | |
| Comparative | 2.2 | 2.77 | 3.66 |
| Example 1-3 | | | |
| Comparative | 4.8 | 2.88 | 8.15 |
| Example 2-2 | | | |
| Comparative | 3.6 | 2.68 | 5.89 |
| Example 2-3 | | | |

It was confirmed from the results shown in Table 4 that the flat plate test pieces of the Examples exhibited small values of both dielectric loss tangent and relative permittivity even in the thickness direction.

### [Test 4]

In order to confirm the effect of the heat treatment of the resin molded article on the dielectric characteristics, the following tests were conducted.

### <Performance Evaluation 3>

### <Measurement of Dielectric Loss Tangent and Relative Permittivity (10 GHz)>

The flat test piece produced in the Test 2 above was placed on a flat stainless steel tray, and heat treatment was performed in a nitrogen atmosphere at a temperature shown in Table 5 (a temperature of about “Tm₂−20° C.”) using an inert oven (manufactured by Yamato Scientific Co., Ltd.) for 3 hours, followed by air cooling. Relative permittivity and dielectric loss tangent of the flat test piece after the heat treatment in the in-plane direction at a frequency of 10 GHz were measured by the SPDR method, Each type of samples was measured for N=4 times each, and the average values of four measurements are shown in Table 5.

### <Calculation of Dielectric Loss Factor F>

The dielectric loss factor F is calculated from the equation (2) above when the heat-treated flat plate test piece was used as in the same manner as in <Performance Evaluation 1>, and is shown in Table 5.

TABLE 5

| | Performance Evaluation | | | |
|---|---|---|---|---|
| | | Dielectric | | |
| | | Loss | | Dielectric |
| | Heat-Treating | Tangent | Relative | Loss |
| | Temperature | tanδ | Permittivity | Factor |
| | (° C.) | (× 10⁻³) | Er | F |
| Example 1-2 | 290 | 0.59 | 3.45 | 1.1 |
| Example 1-4 | 290 | 0.56 | 3.23 | 1.0 |
| Example 1-5 | 290 | 0.50 | 2.96 | 0.9 |
| Example 2-1 | 300 | 0.54 | 3.45 | 1.0 |
| Exarnple 2-3 | 300 | 0.53 | 3.24 | 0.9 |
| Example 2-4 | 300 | 0.49 | 2.96 | 0.8 |
| Example 3-1 | 335 | 0.47 | 3.10 | 0.8 |
| Example 3-2 | 335 | 0.44 | 2.82 | 0.7 |
| Comparative | 255 | 1.66 | 3.43 | 3.1 |
| Example 1-1 | | | | |
| Comparative | 255 | 1.43 | 3.25 | 2.6 |
| Example 1-2 | | | | |
| Comparative | 255 | 1.16 | 2.98 | 2.0 |
| Example 1-3 | | | | |
| Comparative | 335 | 2.10 | 3.40 | 3.9 |
| Example 2-1 | | | | |
| Comparative | 335 | 1.82 | 3.13 | 3.2 |
| Example 2-2 | | | | |
| Comparative | 335 | 1.60 | 2.89 | 2.7 |
| Example 2-3 | | | | |
| Comparative | 290 | 1.29 | 3.37 | 2.4 |
| Example 3-1 | | | | |

It was confirmed from the results in Table 5 that the flat plate test pieces after the heat treatment of the Examples can reduce both the dielectric loss tangent and the permittivity as compared with the flat plate test piece before the heat treatment. In particular, the dielectric loss tangents of the compositions of the Examples fell under 0.6×10⁻³ resulting in extremely small values.

### [Test 5]

The following test was conducted in order to confirm the degree of thermal expansion of the resin molded article.

### <Performance Evaluation 4>

The flat test pieces produced in Test 2 was cut to a width of about 4 mm in the TD direction and the MD direction each to obtain a sample for measurement in a strip form. The sample for measurement was measured for the linear expansion coefficient (CTE) in a tensile mode using a thereto-mechanical analyzer (manufactured by Hitachi High-Tech Science Co., Ltd., model number: TMA7000). The measurement was conducted in an in-between measurement distance of 20 mm, with increasing and decreasing the temperature in a temperature range from 10° C. to 160° C. at a rate of 10° C./min, and for two cycles. The results of the measurement of the average CTE at 30 to 100° C. in the second cycle are shown in Table 6. In addition, the center of the flat plate test piece was cut out into 8×8 mm squares, and measurement was performed in a compression mode as a sample for measurement. The temperature conditions for measurement were the same as in the tension mode, and measurement was performed for two cycles, and the average CTE (ppm K) of 30-100° C. in the second cycle is shown in Table 6.

TABLE 6

| | CTE (30-100° C.) (ppm/K) | | | |
|---|---|---|---|---|
| | x | y | z | Toatl |
| Example 1-1 | −7 | 83 | 103 | 179 |
| Example 1-4 | −10 | 101 | 107 | 198 |
| Example 2-1 | −12 | 83 | 86 | 157 |
| Example 2-2 | −11 | 98 | 97 | 184 |
| Example 2-3 | −11 | 102 | 116 | 207 |
| Example 3-2 | −10 | 104 | 81 | 175 |
| Comparative | −4 | 116 | 130 | 242 |
| Example 1-2 | | | | |
| Comparative | −5 | 157 | 118 | 270 |
| Example 1-3 | | | | |
| Comparative | −9 | 120 | 141 | 252 |
| Example 2-1 | | | | |
| Comparative | −12 | 122 | 152 | 262 |
| Example 2-2 | | | | |
| Comparative | −4 | 136 | 155 | 287 |
| Example 2-3 | | | | |

From the results in Table 6, the resin molded articles of the Examples had the coefficient of linear expansion (CTE) of x, y, and z, totaling to 210 ppm/K or less. On the other hand, the resin molded articles of the Comparative Examples had the coefficient of linear expansion (CTE) of x, y, and z, totaling to more than 240 ppm/K, Therefore, the resin molded articles of the Examples had suppressed thermal expansion as compared with the resin molded articles of the Comparative Examples. Since the smaller the value of the linear expansion coefficient is, and smaller the less thermal expansion is when the resin molded article is subjected to secondary-processing such as mounting, processing, etc., the easier handling becomes, the values are preferred to be smaller as a characteristic of the component.

From the results shown in Table 6, the linear expansion coefficient (CTE) tends to increase as the amount of the fluorine resin (B) increases. When comparing Example 2-1 with Comparative Example 2-1 in which the amounts of the fluorine resin (B) were comparable (10% by mass), Example 2-1 had the thermal expansion suppressed by 30% or more as compared with Comparative Example 2-1, When comparing Examples 1-4 and 2-3 in which the amounts of the fluorine resin (B) were comparable (30% by mass), with Comparative Examples 1-2 and 2-2, Examples 1-4 and 2-3 had the thermal expansion suppressed by 20% or more, compared with Comparative Examples 1-2 and 2-2. Further, when Example 3-2 was compared with Comparative Examples 1-3 and 2-3, in which the amounts of the fluorine resin (B) were comparable (50% by mass), Example 3-2 had the thermal expansion suppressed by 30% or more compared with Comparative Examples 1-3 and 2-3.

As described above, it was confirmed that a specific combination of the liquid crystal polyester resin and the fluorine resin is important for obtaining a resin molded article having a low linear expansion coefficient.

### [Test 6]

The following tests were conducted in order to confirm that the resin molded article according to the present invention exhibits high practical heat resistance.

### <Performance Evaluation 5>

The flat test piece produced in Test 2 above was cut into a size of 30 mm×8 mm (long side in TD direction) to obtain a sample for measurement. The obtained sample was evaluated for practical heat resistance using a dynamic viscoelastic device (DMA, manufactured by Hitachi High-Tech Science Co., Ltd., model number: DMS6100), Specifically, measurement was performed in a tensile mode at 1 Hz, a temperature increasing rate of 6° C. min, and a measurement starting temperature of 30° C., and a point at which the sample was deformed or broken by heat during the temperature escalation process, or a point at which the loss elastic modulus became 1/1000 from the start of measurement was defined as a measurement end point. In the measurement data, the behavior of the material as a liquid is exponentially strengthened by the flat portion, which shows a stable change in physical properties against temperature at 200° C. or higher, which is higher than the glass transition point in the loss elastic modulus graph, and further heating, and the intersection point of each tangent line of the portion immediately before the measurement ended due to the inelastic change or breakage was determined, and the temperature of the intersection point was defined as a practical heat resistant temperature at which the material could not withstand the predetermined stress of the DMA device and broke. The measurement results are shown in Table 7.

TABLE 7

| | | | Difference between |
|---|---|---|---|
| | | | Tm₂ and Practical |
| | | Practical | Heat Resistance |
| | Thickness | Heat | Temperature |
| | of Molded | Resistant | of Liquid Crystal |
| | Article | Temperature | Polyester Resin |
| | (mm) | (° C.) | (° C.) |
| Example 1-1 | 0.4 | 300 | 11 |
| Example 1-2 | 0.4 | 301 | 10 |
| Example 1-3 | 0.4 | 299 | 12 |
| Example 1-4 | 0.4 | 297 | 14 |
| Example 1-5 | 0.4 | 289 | 22 |
| Example 1-6 | 0.8 | 297 | 14 |
| Example 1-7 | 0.8 | 296 | 15 |
| Example 2-1 | 0.4 | 301 | 19 |
| Example 2-2 | 0.4 | 306 | 11 |
| Example 2-3 | 0.4 | 307 | 13 |
| Example 2-4 | 0.4 | 294 | 26 |
| Example 2-5 | 0.8 | 305 | 15 |
| Example 3-1 | 0.4 | 315 | 35 |
| Example 3-2 | 0.4 | 318 | 32 |
| Comparative | 0.4 | 242 | 33 |
| Example 1-1 | | | |
| Comparative | 0.4 | 247 | 28 |
| Example 1-2 | | | |
| Comparative | 0.4 | 248 | 27 |
| Example 1-3 | | | |
| Comparative | 0.4 | 301 | 54 |
| Example 2-1 | | | |
| Comparative | 0.4 | 299 | 56 |
| Example 2-2 | | | |
| Comparative | 0.4 | 295 | 60 |
| Example 2-3 | | | |
| Comparative | 0.4 | 299 | 12 |
| Example 3-1 | | | |
| Comparative | 0.8 | 298 | 13 |
| Example 3-2 | | | |

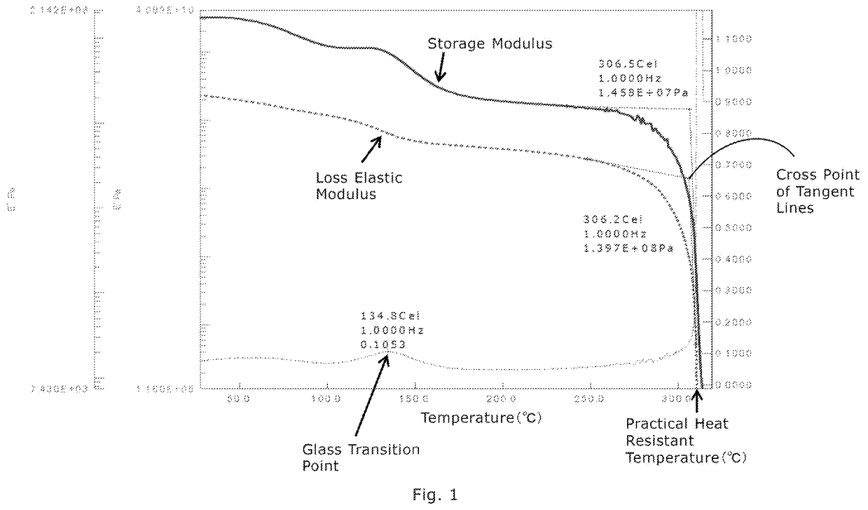

From the results shown in Table 7, the sample in which the liquid crystal polyester resin and the fluorine resin were blended as the raw material showed a comparable practical heat resistance to that of a liquid crystal polyester resin itself as the raw material, and showed an excellent heat resistance that is a characteristic of the liquid crystal polyester. In particular, the samples of the Examples all showed practical heat resistance temperatures of 280° C. or higher, and that they have solder heat resistance as a material. As one example, FIG. 1 shows a graph of the loss elastic modulus for calculating the practical heat resistance temperature of the resin molded article of Example 2-2. It is confirmed that the practical heat resistance temperature almost coincides with the load deflection temperature, which is a heat resistance evaluation as an index of solder heat resistance. The load deflection temperature is an evaluation specified in 315 K7191, and is measured as the temperature at which a specified deflection of 0.11 mm is reached when a load with an in-between distance of supporting points of 64 mm and a load force of 1.80 MPa is applied to a bending test piece under a nitrogen atmosphere by using a load deflection measuring machine No. 148-HD500 manufactured by Yasuda Seiki Company, and the temperature is increased by a measurement starting temperature being 100° C. and a temperature increasing rate of 120° C./hour. The load-deflection temperature of the liquid crystalline polyester resin A2 of Synthesis Example 2 was 281° C., and the practical heat resistance temperature of this sample in the DMA measurement was 297° C. Therefore, it has been confirmed that the practical heat resistance temperature in the DMA measurement is equivalent to the load-deflection test generally used to evaluate the practical heat-resistance.

Further, it has been found that the samples of the Examples has a smaller difference between Tm₂ and the practical heat resistance temperature of the liquid crystal polyester resin as compared with the samples of Comparative Examples 2-1 to 2-3, which exhibit a comparable practical heat resistance to that of the Examples. Since the material of the present invention has achieved a relatively small Tm₂ among the materials having high practical heat resistance such as those showing solder heat resistance, processing is possible even with a molding machine having a small heating capacity, From this point of view, it can be said that the resin composition of the present invention is an excellent material having excellent processing performance and also high practical heat resistance,

### [Test 7]

The following test was conducted in order to confirm the water absorption rate of the resin molded article,

### <Performance Evaluation 6>

The flat test pieces produced in the above-described Test 2 were each measured for the test piece weight in a dry state and the weight after immersing the test piece in water for 24 hours, in accordance with ASTM D570, and the water absorption rate was measured from the weight increase rate, Each type of samples were measured for N=4 times each, and the average values of four measurements were shown in Table 8.

TABLE 8

| | Water |
|---|---|
| | Absorption |
| | Rate (%) |
| Example 1-4 | 0.02 |
| Example 2-3 | 0.01 |
| Example 3-1 | 0.03 |
| Cornparative | 0.03 |
| Example 1-2 | |
| Comparative | 0.05 |
| Example 2-2 | |
| Comparative | 0.05 |
| Example 3-2 | |

From the results in Table 8, the flat plate test pieces of the Examples exhibited extremely small water absorption rates of 0.03% or less, Since water has a permittivity close to 80, if water enters the material, it loses its attraction as a low-dielectric material. Since the material of the present invention has been confirmed as having an extremely low water absorption rate, it has been confirmed that the material can stably exhibit low-dielectric performance even under actual use.

1. A resin composition comprising:
a liquid crystal polyester resin (A) comprising structural unit (I) derived from a hydroxycarboxylic acid, structural unit (II) derived from a diol compound, and structural unit (III) derived from a dicarboxylic acid; and
a fluorine resin (B),
wherein a dielectric loss tangent is 0.80×10⁻³ or less and a relative permittivity is 3.50 or less when measured by a split post dielectric resonator (SPDR) method at a measurement frequency of 10 GHz.

2. The resin composition according to claim 1, having a melt viscosity of 5 Pa·s or more and 250 Pa·s or less under a temperature of a melting point of the liquid crystal polyester resin (A)+20° C. or higher and a shear rate of 1000 s⁻¹.

3. The resin composition according to claim 1, wherein the liquid crystal polyester resin (A) has a melt viscosity of 5 Pa·s or more and 130 Pa·s or less under a temperature of a melting point+20° C. or higher and a shear rate of 1000 s⁻¹.

4. The resin composition according to claim 1, wherein the liquid crystal polyester resin (A) has a melting point of 280° C. or higher.

5. The resin composition according to claim 1, wherein the liquid crystal polyester (A) has the dielectric loss tangent of 1.00×10⁻³ or less measured by a 10 GHz SPDR method.

6. The resin composition according to claim 1, wherein the resin (B) comprises a polytetrafluoroethylene resin.

7. The resin composition according to claim 1, wherein the amount of the liquid crystal polyester resin (A) blended is 30 parts or more by mass and 95 parts or less by mass, and the amount of the fluorine resin (B) blended is 5 or more by mass and 70 parts or less by mass, with respect to a total of 100 parts by mass of the liquid crystal polyester resin (A) and the fluorine resin (B).

8. The resin composition according to claim 1, wherein the structural unit (I) derived from a hydroxycarboxylic acid is a structural unit derived from 6-hydroxy-2-naphthoic acid.

9. The resin composition according to claim 1, wherein the composition ratio of the structural unit (I) to the structural units of the entire liquid crystal polyester resin (A) is 30 mol % or more and 80 mol % or less.

10. The resin composition according to claim 1, wherein the structural unit (II) derived from a diol compound is a structural unit derived from at least one selected from the group consisting of 4,4-dihydroxybiphenyl, hydroquinone, methylhydroquinone, and 4,4′-isopropylidenediphenol.

11. The resin composition according to claim 1, wherein the structural unit (III) derived from a dicarboxylic acid is a structural unit derived from at least one selected from the group consisting of terephthalic acid, isophthalic acid, and 2,6-naphthalenedicarboxylic acid.

12. A resin molded article comprising the resin composition according to claim 1.

13. The resin molded article according to claim 12, wherein the resin molded article after heat treatment has a dielectric loss tangent of 0.70×10⁻³ or less measured by a SPDR method at a measurement frequency of 10 GHz.

14. The resin molded article according to claim 12, wherein the water absorption rate measured in accordance with ASTM D570 is 0.04% or less.

15. An electric or electronic component comprising the resin molded article according to claim 12.

16. The resin composition according to claim 6, wherein the amount of the liquid crystal polyester resin (A) blended is 30 parts or more by mass and 95 parts or less by mass, and the amount of the fluorine resin (B) blended is 5 or more by mass and 70 parts or less by mass, with respect to a total of 100 parts by mass of the liquid crystal polyester resin (A) and the fluorine resin (B).

17. The resin composition according to claim 16, wherein the structural unit (I) derived from a hydroxycarboxylic acid is a structural unit derived from 6-hydroxy-2-naphthoic acid.

18. The resin composition according to claim 17, wherein the composition ratio of the structural unit (I) to the structural units of the entire liquid crystal polyester resin (A) is 30 mol % or more and 80 mol % or less.

19. The resin composition according to claim 18, wherein the structural unit (II) derived from a diol compound is a structural unit derived from at least one selected from the group consisting of 4,4-dihydroxybiphenyl, hydroquinone, methylhydroquinone, and 4,4′-isopropylidenediphenol.

20. The resin composition according to claim 19, wherein the structural unit (III) derived from a dicarboxylic acid is a structural unit derived from at least one selected from the group consisting of terephthalic acid, isophthalic acid, and 2,6-naphthalenedicarboxylic acid.
